(19) United States
(12) Patent Application Publication
(10) Pub. No.: US 2020/0186761 A1
(43) Pub. Date: Jun. 11, 2020

(54) EYE PROJECTION SYSTEMS AND METHODS WITH FOCUSING MANAGEMENT

(71) Applicant: EYEWAY VISION LTD., Yehuda (IL)

(72) Inventor: Boris Greenberg, Tel-Aviv (IL)

(21) Appl. No.: 16/614,537

(22) PCT Filed: May 28, 2018
(86) PCT No.: PCT/IL2018/050582

§ 371 Date: Nov. 18, 2019

(30) Foreign Application Priority Data
May 29, 2017 (IL) 252585

(51) Int. Cl. H04N 9/31; G02B 26/00; G02B 17/08; G02B 27/28; G06F 3/01

(52) U.S. Cl. CPC H04N 9/317; G02B 26/00; G02B 17/08; G02B 2207/117; H04N 9/3194; H04N 9/3155; G06F 3/013; G02B 27/283

(57) ABSTRACT

Eye projection systems and methods with focusing management are presented. The systems comprise an image projection system for generating a light beam modulated to encode image data indicative of an image to be projected towards a subject's eye along a light beam propagation path; and an optical assembly located in said path for directing the light beam between said image projection system and a retina of said eye; the assembly comprises a light beam divergence assembly for controllably varying focusing properties of said assembly and adjusting divergence of said light beam to thereby affect one or more focusing parameters of one or more portions of said image on the retina.

### TECHNOLOGICAL FIELD

The invention is in the field of image projection system, more specifically the invention relates to techniques for providing virtual and/or augmented reality experience to a user.

### BACKGROUND

Wearable, e.g. head mounted, image projection systems for providing virtual and/or augmented virtual reality to the user eye(s) are becoming increasingly popular. Various systems are configured as glasses mountable onto a user's head and operable for projecting images to the user's eyes.

Some of the known systems are aimed at providing pure virtual reality image projections to the user eyes, in which light from the external real-world scenery is blocked from reaching the eye(s), while some other known systems are directed to provide augmented virtual reality perception, in which the light from the external real-world scenery is allowed to pass to the eyes while images/video frames projected to the eyes by the image projection systems are superposed on the external real-world scenery.

Depth and width of field are two of the parameters that should be considered in such virtual or augmented reality projection systems.

For example, WO06078177 describes direct retinal display for displaying an image on the retina of an eye with a wide field of view. The direct retinal display comprises a scan source that is arranged to generate a scanned optical beam, modulated with an image, in two dimensions over a scan angle. The direct retinal display further comprises a diverging reflector in the path of the scanned optical beam that is arranged to reflect the scanned optical beam incident on the diverging reflector outwardly with a magnified scan angle toward a converging reflector that is arranged to reflect the scanned optical beam substantially toward a convergence spot at the pupil of the eye for reconstruction and display of the image on the retina with a wide field of view.

WO15081313 describes a system for presenting virtual reality and augmented reality experiences to users. The system may comprise an image-generating source to provide one or more frames of image data in a time-sequential manner, a light modulator configured to transmit light associated with the one or more frames of image data, a substrate to direct image information to a user's eye, wherein the substrate houses a plurality of reflectors, a first reflector of the plurality of reflectors to reflect transmitted light associated with a first frame of image data at a first angle to the user's eye, and a second reflector to reflect transmitted light associated with a second frame of the image data at a second angle to the user's eye.

WO15184412 discloses a system for presenting virtual reality and augmented reality experiences to users. The system may comprise a spatial light modulator operatively coupled to an image source for projecting light associated with one or more frames of image data, and a variable focus element for varying a focus of the projected light such that a first frame of image data is focused at a first depth plane, and a second frame of image data is focused at a second depth plane, and wherein a distance between the first depth plane and the second depth plane is fixed.

### GENERAL DESCRIPTION

Virtual and augmented reality applications should provide convincingly realistic as well as convenient experience to the user, just as close as possible to the three-dimensional real life. When contemplating the world in the real life, a person sees objects either in focus or out of focus depending on the person's gaze direction/focus and distance from the instantaneous focal plane. Every object we look at directly is in focus because we accommodate our vision to focus on the gaze-centric object and every object in the environment that we do not look at directly and is in a different focal plane, called world-centric object, is not in focus and looks blurred because light coming from it is not focused on the retina of our eyes which are accommodated to focus light coming from the object that we are contemplating at.

Unlike the technique of the present invention, as will be detailed below, some virtual and/or augmented reality systems utilize “extended depth of focus” principle where the user sees all objects in focus irrelevant of their distance from the user and user's accommodation. This effect is achieved by reduction of the exit pupil of the optical system to a level that the depth of focus covers significant accommodation diopter range.

In some potential virtual or augmented reality applications, the virtual object/image should be projected at a fixed location with respect to the three-dimensional surrounding environment, whether virtual or real environment. The object of the virtual image should be in focus whenever the user looks directly towards the virtual object and should be blurred/out of focus whenever the user looks at a different location in the surrounding environment. For example, in construction projects, augmented reality can be usefully utilized to direct the workers to the real-world location of the different building elements, such that the building elements are superposed at a finite location within the real-world environment watched by the workers regardless of the workers gaze focus.

In some other potential virtual or augmented reality applications, the virtual object/image should move with the gaze focus/direction of the user, i.e. it is projected at different locations, with respect to the surrounding environment, corresponding to the gaze focus/direction of the user. In this case, the object of the virtual image should be in focus always. For example, in certain augmented reality games, the user follows a specific virtual character superimposed as moving in the surrounding real-world environment.

Conventional image projection systems for providing virtual or augmented reality to users are generally based on the projection of an image towards the user's eye(s), by forming a focused image on an intermediate image plane, such that the image is perceived by the user as being located at a fixed distance (typically a few meters) in front of the user's eye(s). The depth of focus of such image projection systems is therefore large, and it is difficult to measure and accurately adjust the focal length (the distance to the intermediate plane). However, the eyes, which have good accommodation functionality signal the user and thus the user remains sensitive to inaccuracies in the focal length of the image projection system, and it is particularly problematic when the image is viewed with both eyes, since there may be a discrepancy between the respective focal planes which the eyes look at. In such image projection systems, the intermediate image plane has to be optically relayed to the user's eye(s) and as the intermediate image plane is typically placed at a certain finite distance in front of the eye, it is focused onto the eye retina only when the eye focuses to that certain distance. Projecting images perceived at a certain finite distance from the user eyes relates to the development of eye fatigue, and in many cases, headaches are associated with the fact that while the objects in the projected image may be perceived at various distances from the eye, the image captured by the eye is actually focused at the fixed distance from the eye. This effect which is known as “vergence-accommodation conflict” generally confuses/distresses the visual sensory mechanisms in the brain, yielding eye fatigue and headaches. Furthermore, variations between the relative position and orientation of the eye relative to the image projection systems change the location at which the projected image is perceived by the user eye and cause significant discomfort to persons using the conventional virtual or augmented reality glasses.

There is a need in the art for adjusting the focus and/or location of the virtual object/image based on the specific application, such that the virtual object is in focus whenever the user is looking at the virtual object, whether it is static or mobile with regards to the surrounding, and is out of focus whenever the user is not looking directly at the virtual object, i.e. the user is looking in a different direction and/or focusing on another spot in his field of view.

The present invention provides novel systems and methods that provide natural and realistic virtual or augmented reality experience, in which the virtual object/s is/are dynamically in focus/out of focus based on the specific application, as described above. Therefore, a virtual object will be in focus whenever contemplated by the user and out of focus whenever it is not contemplated by the user.

The present invention also provides novel systems and methods that provide static or moving virtual objects, in and out of focus, with respect to the real/virtual surrounding based on the specific application.

Further, the present invention provides novel systems and methods that provide real-time tracking of eye accommodation that enables dynamic control over the focusing/blurring of the virtual object. Additionally or alternatively, the systems and methods presented assume that the user's accommodation and vergence parameters are obtained from the eye tracking mechanism.

Thus, according to a broad aspect of the present invention there is provided an eye projection system, comprising:

an image projection system configured and operable for generating a light beam modulated to encode image data indicative of an image to be projected towards a subject's eye along a light beam propagation path;

an optical assembly being located in the light beam propagation path and configured and operable for directing the light beam between the image projection system and a retina of the subject's eye, the optical assembly comprising a light beam divergence assembly configured and operable for controllably varying focusing properties of the optical assembly and adjusting divergence of the light beam to thereby affect one or more focusing parameters of one or more portions of the image on the retina of the subject's eye.

In some embodiments, the light beam divergence assembly affects the one or more focusing parameters of one or more portions of the image by maintaining the one or more portions of the image in focus in every gaze distance and/or direction of the subject's eye.

In some embodiments, the light beam divergence assembly affects the one or more focusing parameters of one or more portions of the image by projecting the one or more portions of the image at a fixed spatial location in a field of view of the subject's eye.

In some embodiments, the eye projection system further comprising an eye focal point detection module configured and operable to continuously determine a focal length of the subject's eye and generate eye focal point data to control the light beam divergence assembly. The eye focal point detection module may comprise: a light source arrangement configured and operable to illuminate the subject's eye with a collimated light beam, an optical sensor configured and operable to register reflected light beam from the subject's retina and generate reflection data, and a camera configured and operable to capture images of the subject's eye pupil and generate pupil data, thereby enabling utilizing the reflection and pupil data to determine the focal length of the subject's eye and generate the eye focal point data. Accommodation parameters can be obtained in various other methods, such as auto refractometer, gaze vector convergence point, retinal reflection parameter change detection, etc.

In some embodiments, the light beam divergence assembly comprises an optical element having a controllably variable focusing property.

In some embodiments, the optical assembly comprises a relay lens arrangement.

In some embodiments, the optical assembly comprises at least an input optical element and an output optical element, the light beam divergence assembly being configured and operable to modify a light beam effective distance between the input and output optical elements along the light beam propagation path.

In some embodiments, the light beam divergence assembly comprises an array of light beam deflectors configured and operable to direct the light beam between the input and output optical elements, the light beam divergence assembly being configured and operable to displace at least one light beam deflector of the array.

In some embodiments, at least part of the light beam divergence assembly is positioned before another optical element of the optical assembly along the light beam propagation path.

In some embodiments, the at least part of the light beam divergence assembly comprises at least two optical focusing elements displaceable with respect to each other.

In some embodiments, the at least part of the light beam divergence assembly comprises an optical focusing element having a controllably variable focusing property.

In some embodiments, the focusing element comprises a deformable membrane comprising piezoelectric material being configured and operable to converge or diverge the light beam.

In some embodiments, the at least part of the light beam divergence assembly comprises a beam splitter, a light polarizing element, a focusing element and a light beam deflector arranged sequentially along the light beam propagation path, at least one of the focusing element and light beam deflector being displaceable with respect to the other along the light beam propagation path.

In some embodiments, the eye focal point detection module comprises an eye tracking assembly configured and operable to measure gaze direction of the subject's eye and generate eye positioning data, a camera configured and operable to capture size of pupil of the subject's eye and generate pupil size data, and a controller configured and operable to utilize the eye positioning data and the pupil size data and generate the focal point data.

According to another broad aspect of the present invention, there is provided a method for determining one or more focusing parameters of one or more portions of an image on a retina of a subject's eye, the method comprising:

receiving image data input indicative of an image to be projected to a user's eye; the image data comprises information about color, intensity, distance and whether the image is gaze-centric or world centric;

receiving, for each image datum of the image data, eye focal point data indicative of instant eye focal length;

generating, for each image datum of the image data, focusing and light beam divergence data;

generating, for each image datum of the image data, a light beam encoding each image datum based on the image data, the eye focal point data and focusing and light beam divergence data; and

projecting the light beams encoding the image data in a desired temporal or spatial order towards the subject's eye.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1E illustrate schematically various configurations of focusing mechanisms of an eye projection system in accordance with the present invention;

FIGS. 2A-2D illustrate schematically various configurations of eye focal point determination mechanisms of an eye projection system in accordance with the present invention;

FIGS. 3A-3C illustrate schematically one non-limiting example for using the eye projection system of the present invention; and

FIG. 4 illustrates a method for adjusting focusing parameters of an image in accordance with the present invention.

### DETAILED DESCRIPTION OF EMBODIMENTS

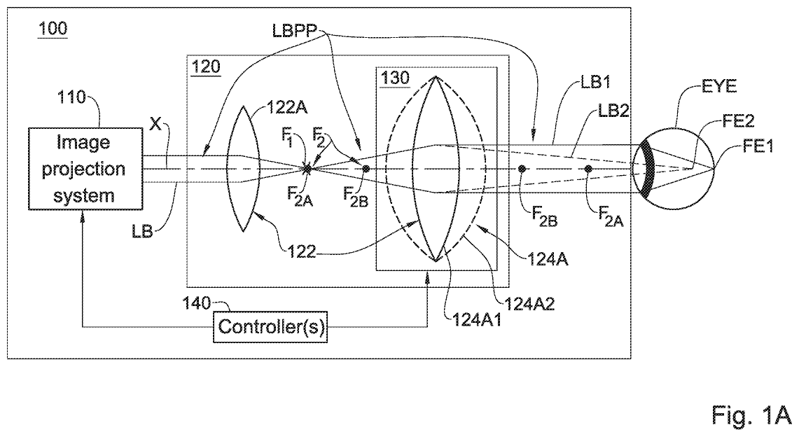

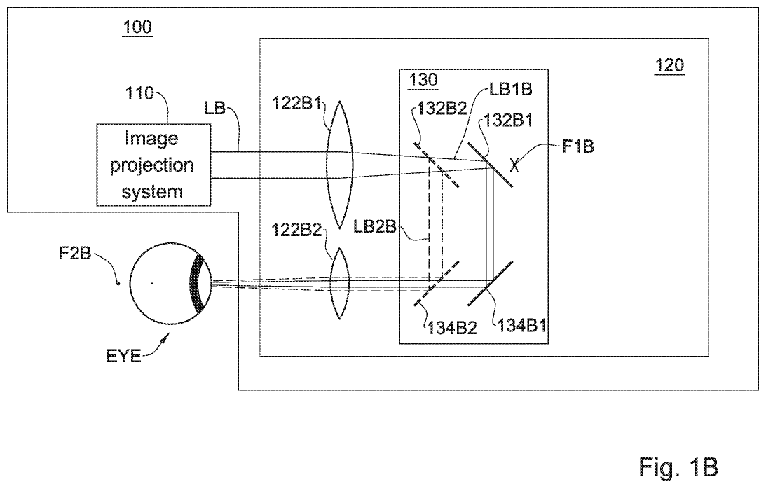

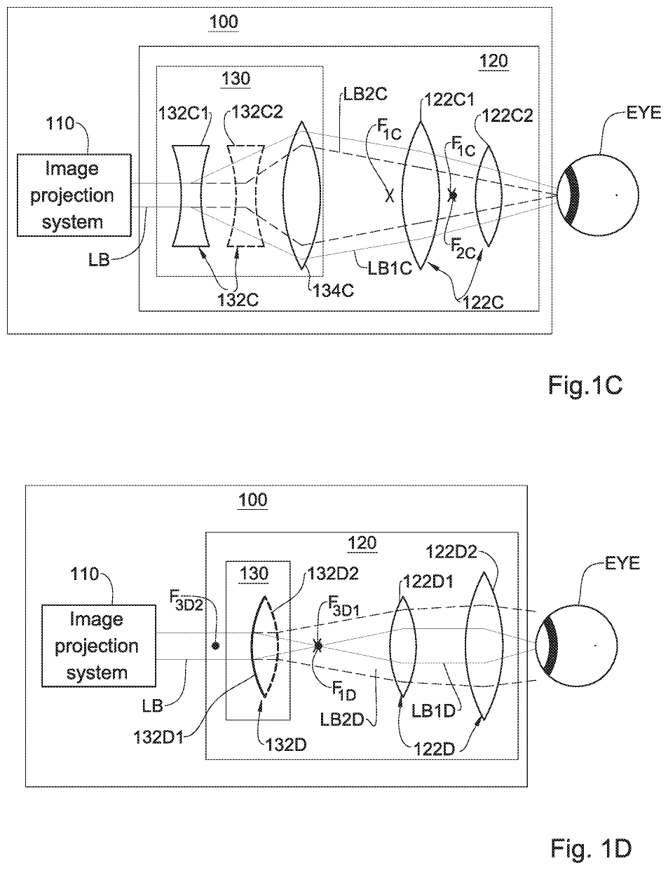

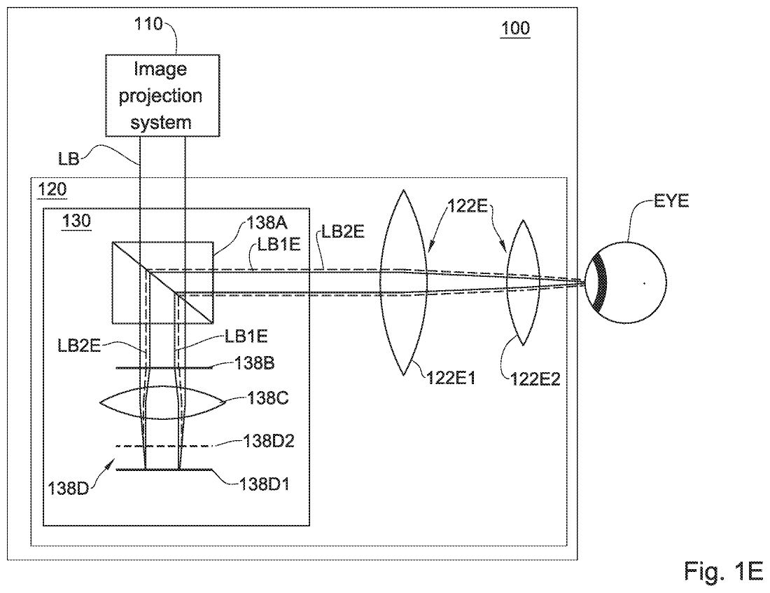

Reference is made to FIGS. 1A-1E which are block diagrams schematically illustrating an eye projection system 100 according to five non-limiting exemplary embodiments of the present invention. It is noted that the figures are illustrative only and are not meant to be in scale. The eye projection system 100 of the present invention is specifically designed for use in virtual or augmented reality applications, though various aspects of the invention can be also used in other fields. The eye projection system 100 is configured and operable to control focusing of light beams originating (emerging or reflecting) from objects located in a field of view of a subject, and can be for example part of a virtual or augmented reality wearable device. The latter can include two eye projection systems, such as the eye projection system 100, each one is used for projecting images to one of the two human eyes. For the sake of simplicity, only one eye projection system 100 is specifically shown in the figures. Also, It is noted that, for clarity and simplicity, common elements and/or elements having similar/identical functionalities are designated by the same or similar reference numerals/symbols.

Generally, as shown, the eye projection system 100 includes an image projection system 110 that generates light beams LB that form the image on the retina/fovea of the subject's eye, an optical assembly 120 and a light beam divergence assembly 130 included within the optical assembly 120, that together transport the light beams to the eye and control the focus of the image, and one or more controllers 140 that control the operation of the image projection system 110 and/or the optical assembly 120, particularly the light beam divergence assembly 130, to produce the image with the required focusing on the retina/fovea of the subject's eye EYE.

The image projection system 110 is configured and operable for generating a light beam LB that is modulated by encoding image data indicative of an object/image to be projected towards a subject's eye EYE, specifically towards the retina and fovea, along a light beam propagation path LBPP. It is noted that, in general, the image projection system 110 produces one modulated light beam LB which is sequentially encoded with image data. The modulated light beam LB is then projected on the user's eye via the optical assembly 120. The light beam LB can be configured as a laser beam with preconfigured properties, such as the chromatic distribution (RGB) and intensity, in order to genuinely encode the image data indicative of an object/image to be projected. Generally, each instantaneous light beam is modulated by one image datum representing one pixel in the object/image to be projected. Therefore, for example, for projecting an image of 1280×720 pixels, at least 921,600 modulated light beams LB are encoded by the 921,600 image data pieces and projected towards the eye via an optical system that includes the optical assembly 120. The frame rate of projecting the whole image is determined such that it is higher than the frame rate of the human eye. Detailed description about the generation of the object/image by the image projection system 110 is found in WO 15132775 and WO 17037708 both assigned to the assignee of the present invention and incorporated herein by reference.

As shown in the FIGS. 1A-1E, the optical assembly 120 is optically coupled to and located in the light beam propagation path LBPP between the image projection system and the subject's eye EYE. The optical assembly 120 is configured and operable for transporting and directing the light beam LB between the image projection system 110 and the subject's eye EYE, specifically to the Retina and more specifically to the Fovea of the subject's eye EYE.

The optical assembly 120 includes the light beam divergence assembly 130 which is configured and operable for controllably varying focusing properties of the optical assembly 120 such as by adjusting divergence of the light beam LB to thereby affect one or more focusing parameters of one or more portions of the image on the subject's eye EYE.

It is known that the human eye focuses on an object through eye accommodation that involves adjusting the focal point/length of the eye such that light arriving from the object in focus is focused/converges at the focal point of the eye and produces a focused image on the retina/fovea. In other words, an observed object will be in focus if and only if the light emerging/reflected from it converges at the focal point of the subject's eye.

The light beam divergence assembly 130 affects the divergence/convergence of the light beam LB that carries the image to the subject's eye by travelling along the light beam propagation path LBPP, to dynamically cause focusing and defocusing of the image or portions thereof. Consequently, for the subject to see the image/object in focus, the light beam divergence assembly 130 is configured to maintain the one or more portions of the image/object in focus in every gaze distance and/or direction of the subject's eye, i.e. by converging the light beam LB at the focal point of the eye. And for the subject to see the image/object out of focus, when not looking at it directly, exactly as in the real life, the light beam divergence assembly 130 is configured to project the one or more portions of the image/object at a fixed spatial location in a field of view of the subject's eye and/or to converge the light beam LB at a location which is different from the focal point of the subject's eye. It should be noted that, the image can be comprised of RGB components and convergence of each color (R, G, B) can be controlled either simultaneously or separately.

The one or more controllers 140 are configured and operable to generate controlling signals to the image projection system 110 and/or the light beam divergence assembly 130 in order to produce and direct each light beam LB that encodes each image datum such that the image is projected on the retina/fovea with the required focus and depth of field as described above. It is noted that, the eye projection system 100 can include one central controller being in communication with all the elements/assemblies/subsystems included in the eye projection system 100, such that it controls all of the operation of the eye projection system 100. Or, each element/assembly/subsystem or a combination thereof can include its own local controller that can receive input data from or send output data to other parts of the eye projection system 100. Therefore, whenever a controller action is mentioned herein through the application it can be either from a central controller or a local controller, and even if no controller is specifically shown in a figure, it is assumed that every element/assembly/subsystem has its own local controller or is controlled by the central controller of the whole eye projection system 100. More details about the controller(s) 140 are described further below.

In the description below, various implementations are described for the optical assembly 120 and the light beam divergence assembly 130. It is noted that the specific embodiments are for illustration only and are by no means limiting the invention. Further, it is noted that for simplicity of presentation different simplifying assumptions are made, such as the idea that the light beam LB being input to the optical assembly 120 as a collimated beam (from the image projection system 110), however it is appreciated by a man versed in the art that the light beam LB can be input as a converging/diverging beam as well without any limitation. Yet further, it should be understood that the figure-specific examples given with respect to the condition(s) of the output light beam exiting the optical assembly 120 and the eye projection system 100 towards the user's eye are illustrative and simplified, whereas any other possible condition of the output light beam can be practiced by the present invention without limitation. Moreover, it should be understood, though not necessarily or specifically shown, that the present invention is capable of producing an output light beam towards the subject's eye having any required property such as specific divergence, convergence, frequency, amplitude, width, intensity, angle of incidence with the eye, or any combination thereof in order to produce the required virtual or augmented reality experience, such as the three-dimensionality and focusing profile across the produced virtual image/object.

Turning to FIG. 1A, a first non-limiting example of the optical assembly 120 of the present invention is shown. The image projection system 110 continuously produces a series of light beams LB that each usually encodes one image datum indicative of one pixel in the image. Every light beam LB is directed by a suitable directing mechanism which is not specifically shown, described in detail as mentioned above in previous co-assigned patent applications, so that the light beam propagates in a direction associated with the location of the pixel in the image that the light beam is aimed to produce. The light beam LB travels along the propagation path LBPP by passing along the optical assembly 120 and the light beam divergence assembly 130 included therein, both responsible for carrying the light beam LB towards the eye and controlling the focusing parameters of each light beam LB. The light beam LB then enters the subject's eye EYE and hits the retina/fovea at the back of the eye EYE based on the focus target, such that it converges at the focal point of the subject's eye EYE if it should be in focus, i.e. the subject is looking at the image, or part thereof, produced by the light beam LB. Or, it does not converge at the focal point of the subject's eye EYE if it should not be in focus, i.e. the subject is not looking at the image, or part thereof, produced by the light beam LB.

As mentioned, the optical assembly 120 includes one or more optical elements configured and operable to transport the light beams LB indicative of the image to be projected to the subject's eye, between the exit of the image projection system 110 and the subject's eye EYE. In the described non-limiting example, the optical assembly 120 includes optical elements forming a relay lens system 122 including two consecutive converging lenses 122A and 124A. The lens 122A has a focal point F1 and the lens 124A has a variable focal point F2, with two positions illustrated F2A and F2B. The two lenses are arranged such that their optical lens axes are congruent and located along the optical axis X. It should be noted that, the optical assembly 120 can include other optical elements, such as more lenses as required.

The optical assembly 120 includes the light beam divergence assembly 130 which includes/is formed by the second lens 124A. The second lens 124A, in this case the output lens, has a variable focusing property such that its focal point F2 can be altered and changed. As shown, the focal point F2 is shown in two positions F2A and F2B corresponding respectively to two illustrated configurations 124A1 and 124A2 (dashed line) of the lens 124A. As can be understood, a lens having a variable/modifiable focal point/length can change the divergence/convergence of the light beam falling on it. The light beam divergence assembly 130 can therefore controllably adjust the focusing property(ies) of the optical assembly 120 such that the light beam passing therethrough is diverged/converged in a controllable manner. As mentioned above with respect to configuration of the light beam LB, it should be noted that such configuration can operate in various, not necessarily telecentric, modes.

As demonstrated, the light beam LB enters the optical assembly 120, from the side of the first lens 122A, as a collimated beam parallel to the optical axis X, and therefore converges at the focal point F1 of the first lens 122A. If the second lens is in its configuration 124A1, its focal point is at F2A, which is coincident with the focal point F1, and the light beam LB will exit the second lens 124A as a collimated beam LB1 in parallel to the optical axis X (as shown by the full lines). This means that the image produced by the light beam LB1 is in focus at infinity. In other words, the image produced by the light beam LB1 is going to be in focus if the subject is focusing his sight at infinity by looking at a faraway object, or out of focus if the subject is focusing his sight at a close distance. In the human realm, it can be considered that an object which is far from the subject by about 6 meters or more is located at “infinity”, i.e. the focus of the subject's eye does not change from about 6 meters and more. When a human eye is focusing on infinity, the eye focal point is located on the retina at the maximal focal length of the eye, as illustrated by the eye focal point FE1. In the second illustrated situation, in which the focal point of the second lens is positioned at point F2B, the light beam LB will exit the second lens 124A as a converging beam LB2 (as shown by the dashed lines) which eventually converges at some point after the focal point F2B, for example at the focal point FE2 of the subject's eye EYE. This means that the image produced by the light beam LB2 is produced and is in focus at the location where the subject is focusing his sight. Accordingly, the light beam divergence assembly 130 of the present example includes an optical element having a controllably variable focusing property, thereby affecting the focusing parameters of one or more parts of the image. This way, it is possible to produce a realistic virtual or augmented reality scene, by producing focused images at the sight location of the subject (at the location where he focuses his sight, gaze-centric), and unfocused images at locations outside the sight location (world-centric). As can be understood from the description above, since each controlled light beam represents only part of the whole projected image, e.g. one pixel in the image, the eye projection system of the present invention enables producing images that include focused and unfocused, blurred, objects within the same projected image, i.e. simultaneously, so that a three-dimensional perception with a controlled depth of field is achievable.

FIG. 1B shows a second non-limiting example of the optical assembly 120 of the present invention. In this example, the optical assembly 120 includes an input and output optical elements along the optical assembly 120 and is configured specifically as a relay lens system 122B with two converging, biconvex, lenses 122B1 and 122B2 in series, with focal points FIB and F2B respectively. Again, it should be understood that this arrangement is selected for simplicity of illustration only and it does not limit the present invention, the optical assembly 120 can be configured in a variety of configurations based on the specific structure, purpose and functionality of the eye projection system. The optical assembly 120 includes a light beam divergence assembly 130 that is configured to adjust the focusing property of the optical assembly 120 by controlling convergence/divergence of the light beam LB. The exemplified light beam divergence assembly 130 includes a beam effective distance modifier configured and operable for varying the divergence of the light beam LB propagating therein by providing an effective light beam distance, achieved by modifying the distance that the light beam LB passes between the input and output optical elements along the light beam propagation path. The beam effective distance modifier is implemented in this non-limiting example by two optical beam reflectors 132B and 134B, e.g. two mirrors, located in the light beam propagation path LBPP and configured and operable to be controllably movable/displaceable inside the light beam propagation path LBPP to thereby change the effective distance between the input and output lenses 122B1 and 122B2. It is noted that for simplicity of illustration, while not limiting or binding the invention, the light beam LB is assumed to be collimated at several portions of the light beam propagation path, except for the immediate portions after the output lens. As shown, the light beam LB meets the first, input, lens 122B1 firstly and converges downstream until it impinges upon the beam effective distance modifier. In the first exemplified path (illustrated by full lines), when the beam effective distance modifier is at a first position, the light beam LB1B is reflected from the first reflector/mirror at 132B1, propagates downwards until it impinges on the second reflector at 134B1 and is reflected to the left towards the second, output, lens 122B2 where it is converges and exits towards the subject's eye EYE. The second exemplified light beam LB2B follows a similar path except that it passes a shorter distance between the input and output lenses (as exemplified by the dashed lines). The light beam LB2B is reflected from the first reflector at 132B2 and then from the second reflector at 134B2 which are closer to the input and output lenses. Therefore, the light beam LB2B is less converged, and more diverged, than the light beam LB1B, as they exit and fall on the subject's eye EYE.

FIG. 1C shows a third non-limiting example of the optical assembly 120 of the present invention. In this example, the optical assembly 120 includes a relay lens system 122C with two converging, biconvex, lenses 122C1 and 122C2 in series, arranged such that their focal points F1C and F2C intersect (the lenses are distanced by the sum of their focal lengths). It should be understood that this arrangement is selected for simplicity of illustration but it does not limit the present invention and the optical assembly 120 can be configured in a variety of configurations based on the specific structure of the eye projection system. The light beam divergence assembly 130 includes an array of optical elements located at the entrance to the optical assembly 120, downstream the exit of the image projection system 110. The array of optical elements of the light beam divergence assembly 130 includes one or more optical elements configured to be displaceable with respect to the rest of optical elements of the light beam divergence assembly 130. This displacement enables controlling the overall divergence/convergence of the light beam LB and affecting the focusing parameters of one or more parts of the image produced by the light beams. Specifically, in the described example, the light beam divergence assembly 130 includes two lenses 132C and 134C in series, where the lens 132C is movable/displaceable with respect to the static lens 134C. As a non-limiting example, the lens 132C is chosen as a biconcave diverging lens and the lens 134C is chosen as a biconvex converging lens. Therefore, looking at a first position of the lens 132C at 132C1, the light beam LB that starts as a collimated beam parallel to the optical axis X, propagates along the propagation path LBPP as LB1C as illustrated by the full lines. The light beam LB is diverged by lens 132C at 132C1, then it is converged three times by the lenses 134C, 122C1 and 122C2 respectively. When the lens 132C is at a second position 132C2 closer to the lens 134C, the light beam LB propagates along the propagation path LBPP as LB2C as illustrated by the dashed lines. The light beam LB is diverged by lens 132C at 132C2, then it is converged three times by the lenses 134C, 122C1 and 122C2 respectively. As appreciated, in this example the light beam LB1C will converge at a point after the point at which the light beam LB2C converges. Therefore, the light beam LB1C can be used to present a focused object/image at the subject's retina/fovea that is at a different distance from (in this case, more far than) a focused object/image at the subject's retina/fovea presented by the light beam LB2C. Put another way, if the subject focuses on an object/image produced by the light beam LB1C, the object/image produced by the light beam LB2C will be blurred and perceived as being closer to the subject. If, alternatively, the subject focuses on an object/image produced by the light beam LB2C, the object/image produced by the light beam LB1C will be blurred and perceived as being more distant from the subject.

FIG. 1D shows a fourth non-limiting example of the optical assembly 120 of the present invention. In this example, the optical assembly 120 includes a relay lens system 122D with two converging, biconvex, lenses, lens 122D1 with a focal point F1D and lens 122D2 in series. Again, it should be understood that this arrangement is selected for simplicity of illustration only and it does not limit the present invention, the optical assembly 120 can be configured in a variety of configurations based on the specific structure, purpose and functionality of the eye projection system. The light beam divergence assembly 130 includes an optical element 132D having variable focusing/defocusing property, e.g. it is configured to variably converge or variably diverge the light beam LB such that the convergence or divergence of the light beam are fully controlled as required by the specific application. In one non-limiting example, the optical element 132D is a deformable membrane that includes piezoelectric material such that applying electrical voltage to it causes the membrane 132D to deform and change its focusing property between convergence and divergence and/or its focusing power in either condition. As illustrated by two non-limiting examples of the light beam propagation paths LB1D and LB2D, the optical element 132D of the light beam divergence assembly 130 enables controlling the convergence/divergence of the light beam LB and provides different focusing properties of the optical assembly 120 to thereby affect focusing parameters of one or more parts of an image encoded into the light beam LB. In the first non-limiting example describing the first path of the beam LB1D, the optical element is configured as a converging element 132D1, the collimated light beam LB hitting the converging element 132D1 converges at focal point F3D1, which in this example coincides with the focal point F1D of the lens 122D1. The light beam LB1D then hits the lens 122D1 and propagates as a collimated beam because it passed through the focal point F1D of the lens 122D1. Then, when it hits the lens 122D2 as a collimated beam, it should converge and focus at the focal point of the lens 122D2. However, as shown the light beam LB1D falls on the pupil of the subject's eye EYE, and is further converged by the subject's eye EYE. In the second non-limiting example describing the second path of the light beam LB2D (in dashed lines), the optical element is configured as a diverging element 132D2 with a focal point F3D2. The collimated light beam LB hitting the diverging element 132D2 diverges and propagates towards the lens 122D1. When the light beam LB2D hits the lens 122D1 and 122D2 it converges respectively and propagates such that it will converge at a point after the focal point of the lens 122D2. Once again, the subject's EYE will need to accommodate its focal point/length differently in order to focus on either the image produced by Light beam LB1D or LB2D. In other words, the subject's eye EYE cannot focus on both images carried by LB1D and LB2D unless its focal point/length is accommodated accordingly. Therefore, if the light beams LB1D and LB2D hit the subject's eye EYE at a rate higher than refresh rate of the human eye or higher than the time needed for eye accommodation, then it is not possible to visualize both images carried by the light beams in focus. It is either only one image will be in focus or both will be out of focus (the latter happens if the subject is focusing on a location different from locations from which both light beams arrive).

FIG. 1E shows a fifth non-limiting example of the optical assembly 120 of the present invention. In this example, the optical assembly 120 includes a relay lens system 122E with two converging, biconvex, lenses 122E1 and 122E2 in series. As mentioned above, it should be understood that this arrangement is selected for simplicity of illustration only and it does not limit the present invention, the optical assembly 120 can be configured in a variety of configurations based on the specific structure, purpose and functionality of the eye projection system. The light beam divergence assembly 130 includes a plurality of optical elements arranged along the light beam propagation path LBPP as follows. The light beam LB falls on a beam splitter/combiner 138A that allows the whole light beam to pass, then the light passes through a light polarizing filter 138B that polarizes the light beam LB. Such light polarizing filter can be configured as a quarter-wave plate. Afterwards, the beam light LB is converged/diverged by a lens 138C, in this case a biconvex converging lens is illustrated, and the light beam continues until it encounters an optical beam deflector 138D, such as a reflecting mirror, and the light beam is reflected back towards the lens 138C. As appreciated, modifying the distance between the lens 138C and the reflecting mirror 138D provides a beam effective distance modifier, as with the example of FIG. 1B, that affects the convergence/divergence of the light beam LB. For example, as illustrated, if the light beam is reflected by the mirror 138D at 138D1, the reflected light beam LB1E will be more converged relative to the light beam LB2E (dashed lines) that is reflected by the mirror 138D at 138D2. As appreciated, after being converged for a second time by the lens 138C, the light beam LB1E/LB2E is polarized one more time by the quarter-wave plate, and as a result the light beam is out of phase with respect to the light beam LB and it is refracted by the beam splitter 138A to the right in the figure. The light beams LB1E and LB2E interact with the lens 122E1 and 122E2 and exit towards the subject's eye EYE as two different beams with respect to their convergence/divergence.

It should be noted that, although the above described non-limiting examples utilize refractive optical elements, the same principles are also effective for reflective and diffractive optical elements with optical power. One of the benefits of this system is that though it describes a plurality of light beams, its general field is constant and therefore significantly simplifies implementation requirements.

As mentioned above, the present invention also provides systems and methods for monitoring and detecting the focal point/length of the subject's eye, such that the continuous detection enables to control and operate the optical assembly including the light beam divergence assembly and focus or un-focus the light beam produced by the image projection system on the detected focal point of the subject's eye based on the desired result, i.e. focus the light beam if the projected image needs to be in focus, e.g. when the subject is looking at the image, or un-focus the image if it does not need to be in focus, e.g. when the subject is looking away from the projected image.

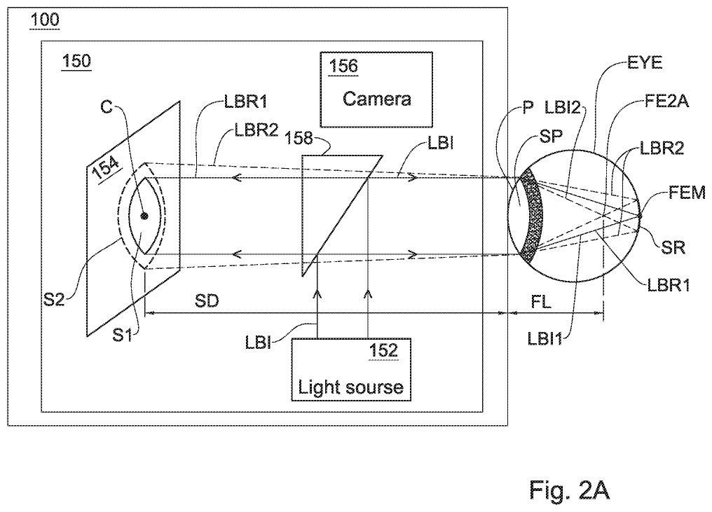

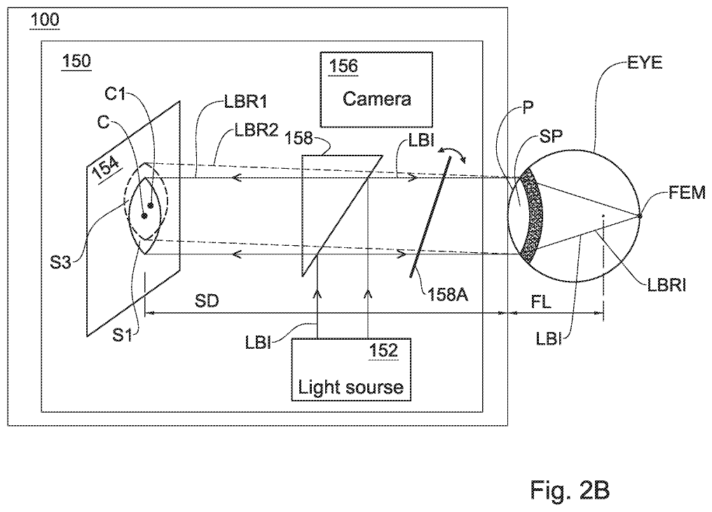

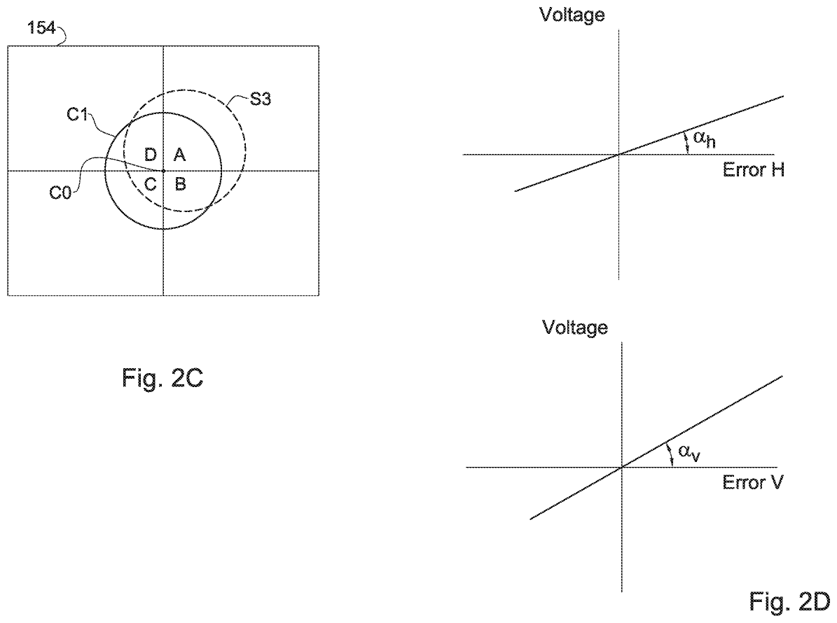

Reference is now made to FIGS. 2A-2D, illustrating schematically an eye focal point detection system/module 150 that can be included in the eye projection system 100. It is noted that the eye focal point detection system/module 150 can be integrated within the eye projection system 100 together with the optical assembly 120, the image projection system 110 and the controller 140 (or, alternatively, a local controller can be included in the eye focal point detection system/module 150 and configured to communicate with one or more other controllers in the eye projection system 100). For simplicity of illustration, FIGS. 2A-2D show the eye focal point detection system/module 150 alone, however this should not be considered as limiting the invention. The eye focal point detection system 150 is configured and operable to continuously monitor the eye focal point/length and generate focal point data indicative thereof. The focal point data can be utilized by one or more components of the eye projection system 100 to affect the focusing parameters of one or more parts of an image projected towards the subject's eye.

As shown in a first non-limiting example of FIG. 2A, the eye focal point detection system/module 150 includes a light beam source 152, a light sensor 154, a camera 156, and an optional beam splitter/combiner 158. Also, as described above, in this example a local controller (140A) is included although not specifically shown. The light beam source 152 is configured and operable for continuous illumination by generating a collimated light beam LBI which propagates towards the subject's eye EYE as a collimated beam. The general propagation path of the light beam LBI can be a straight one or a broken one as shown. In the latter case, one or more beam deflectors or beam splitters/combiners can be optically coupled to the general propagation path such that they direct the collimated beam LBI towards the subject's eye EYE. In the non-limiting described example, the light beam source 152 is positioned at a right angle 90° with respect to the subject's eye EYE, so a beam splitter/combiner 158 is utilized to deflect the light beam LBI towards the subject's eye EYE.

The light generated by the light beam source 152 is a light having a spectrum that is not or is almost not absorbable by the eye, specifically the retina. For example, such light can be in the infra-red range, such that firstly it does not disturb the subject even when looking directly to the source of light, because it is not in the seen spectrum, and secondly it is not absorbed but rather scattered by the retina from the eye.

The optical sensor 154 included in the eye focal point detection system 150 is configured to collect and detect the light beam reflected from the subject's eye EYE. The sensor is distanced with a known distance SD from the pupil P of the subject's eye EYE.

In the illustrated example of FIG. 2A, two reflected light beams are demonstrated in response to the same incident light beam LBI, as a result of two positions/conditions of the focal point of the eye. In the first non-limiting example, the focal point FEM of the eye is located at the maximal focal length of the eye, i.e. it is located at the retina at the back of the eye. This is the focal point position when the subject is looking at “infinity”, i.e. far away. In this case, as shown, the collimated light beam LBI inters the eye propagating along the path LBI1 until it is focused on the retina at the focal point FEM and is reflected backwards along the path LBR1 which coincides with the incident light beam LBI1, then after exiting the eye, the reflected light beam propagates along the path LBR1 which is coincident with the path LBI until reaching the beam splitter/combiner 158 and proceeds in the same direction and divergence (which is zero) until it hits the sensor 154. In the second non-limiting example, the focal point FE2A of the eye is located at the certain focal length FL of the eye, in front of the retina of the eye. This is an exemplary focal point position when the subject is looking at an object close to him, i.e. closer than “infinity”. In this case, as shown, the collimated light beam LBI inters the eye propagating along the path LBI2 focusing at the focal point FE2A and then it scatters and forms a large image spot SR on the retina. When reflected backwards from the retina the light beam propagates along the exemplary path LBR2 which is different from the incident light beam path LBI2. Then, after exiting the eye, the reflected light beam propagates along the path LBR2 which is illustrated by dashed lines until the beam splitter/combiner 158 and proceeds in the same direction and divergence (which is not zero) until it hits the sensor 154. Therefore, in the two described scenarios, the reflected light generates two different detectable spots on the sensor 154 having two areas S1 and S2. Generally, the optical sensor 154 generates an output relative to/proportional to the area of the spot, the output can be in the form of an electric current or voltage for example.

The camera 156 is configured and operable to capture images of the eye's pupil P at a predetermined rate, preferably as large/quick as possible. The area SP of the pupil can be calculated from the pupil images.

Accordingly, the eye focal point detection system 150 is configured and operable to determine the focal point/length FL of the eye at each given time based on at least the following parameters: the area of the spot on the sensor (SI, S2), the area of the pupil SP and the distance of the sensor from the pupil.

The controller 140A (or the central controller 140 of the eye projection system 100) can be configured for operating each or some of the light beam source 152, the light sensor 154, the camera 156, and the beam splitter/combiner 158. The controller 140A receives data from the camera 156 and the optical sensor 154 and calculates the instant eye focal length FL. The controller 140A generates output data indicative of the eye focal length FL and sends the output data to the central controller 140, or to other local controllers as the case may be, in order control the light beam divergence assembly 130 and adjust the light beam divergence so as to control the focusing properties of the optical assembly 120 and affect the focusing parameters of one or more parts of the image projected to the subject's eye EYE.

It should be noted that, in the example of FIG. 2A, it is assumed that the subject is looking all the time in the same direction towards the sensor 154, and hence the spots S1 and S2 on the sensor have a mutual center C. However in reality the human eye keeps moving, sometimes rapidly, such as in a so-called saccadic movements. For this, the eye projection system 100 or the eye focal point detection system 150 may include an eye tracking mechanism configured and operable to track the eye movements and redirect the incident and/or reflected light beams towards and/or back from the eye. Such an eye tracking mechanism is described in the above-mentioned WO17037708 assigned to the assignee of the present invention and incorporated herein by reference. In case an eye tracking mechanism is employed, if the eye focal point detection system 150 is integrated in the eye projection system 100 together with some other structural/functional elements, such as the eye tracking mechanism, one or more parts of the eye focal point detection system 150 may be located after/beyond one or more parts of the eye tracking mechanism. Alternatively, regardless of other systems in the eye projection system 100, the eye focal point detection system 150 may include additional elements, basically light directing/deflecting elements, to enable adjustment of the incident/reflected light beams and/or enable inclusion of the eye focal point detection system 150 inside the size-limited eye projection system.

Turning now to FIG. 2B, there is illustrated another non-limiting example of the eye focal point detection system 150 that includes one or more light deflecting element(s) 158A optically coupled to the incident and/or reflected light beam path(s) and configured and operable to adjust the propagation path(s) of the incident/reflected light beam(s) from the light source 152 towards the eye and back from the eye towards the sensor 154. The one or more deflection elements 158A can be configured to deflect the light propagating towards the eye in order to maintain the collimation condition of the incident light beam. It is noted that, the number of the deflection elements can be chosen to enable adjusting the light beams (incident and reflected) in each possible axis corresponding to the eye saccadic movements. Therefore, though only one deflecting element 158A is shown in the figure, at least two deflecting elements may be used to redirect the light beams in response to the lateral and vertical eye movements respectively. For simplicity only, the non-limiting example shown includes one deflecting element.

As shown in the figure, all of the elements in the system 150 have the same functionality as described in FIG. 2A except for the deflecting element 158A being optically coupled to the incident and reflected light beams paths, between the eye and the light source 152 and between the eye and the sensor 154. In this non-limiting example, it is assumed that the eye moves only vertically, such that the deflecting element is configured to track the eye movement and deflect the incident beam such that the latter is always collimated when hitting the subject's eye EYE. The deflecting element 158A is also configured to deflect the reflected beam such that the spot it creates on the sensor 154 falls at the center of the sensor 154. However, due to a mismatch between the slow response time of the deflecting member relative to the rapid saccadic movements of the eye, the spot created on the sensor 154 is not always at the center and also it is not a circle as would be expected if the subject's eye EYE and the sensor 154 are fully aligned. In other words, the deflection element has a time-lag causing for errors in the measurements. Therefore, the area of the spot cannot be used to determine the eye focal point accurately. For this, a correction should be made as will be described further below.

In FIG. 2B, an example of a subject looking at infinity is exemplified without limiting the invention. The full line LBR1 exemplifies a situation in which the line of sight of the subject is directed towards the sensor 154, such that the spot S1 is created at the center C₀ of the sensor. The dashed line exemplifies the propagation of the reflected beam LBR2 after the subject has moved his eyes and before the deflection element deflects and redirects the light beam. As appreciated, the spot S3 created on the sensor is not central and/or not circular, and the area S3 cannot be used to accurately determine the eye focal length.

Turning to FIG. 2C, a non-limiting example of the sensor 154 is shown. The sensor 154 is configured as a quad sensor having its sensing surface divided into four equal quarters. On the sensor, the two spots S1 and S3 from FIG. 2B are illustrated. As appreciated, the spot S1 is located at the center of the sensor 154 and the spot S3 is located outside the center of the sensor. In this example, it is possible to define an error of the reading at the sensor, as follows: if the voltage produced by each of the partial areas of the spot located respectively in the quarters 1 to 4 is A, B, C and D respectively, then it is possible to assume that:

The horizontal error (the extent by which the spot is deviated horizontally from the center, can be expressed as follows:

$$ErrorH = \frac{( A + B ) - ( C + D )}{A + B + C + D} ;$$

The vertical error (the extent by which the spot is deviated vertically from the center, can be expressed as follows:

$$ErrorV = \frac{( A + D ) - ( B + C )}{A + B + C + D} ;$$

It is possible to plot the ErrorH and ErrorV against the voltage read at the sensor 154, as shown in FIG. 2D, to obtain αn and αv as values indicative of the respective error(s) and deviation(s) from the sensor center. The alpha values, αn and αv, are inversely proportional to the spot area and therefore convey the difference/change in the spot size and consequently the accommodation of the eye. As can be seen, if the spot is centralized at the sensor, the horizontal and vertical errors should be zero and no correction is needed, i.e. the spot area can be used as is to calculate the eye focal length as explained above. However, if at least one of the error values is not zero then a correction is applied.

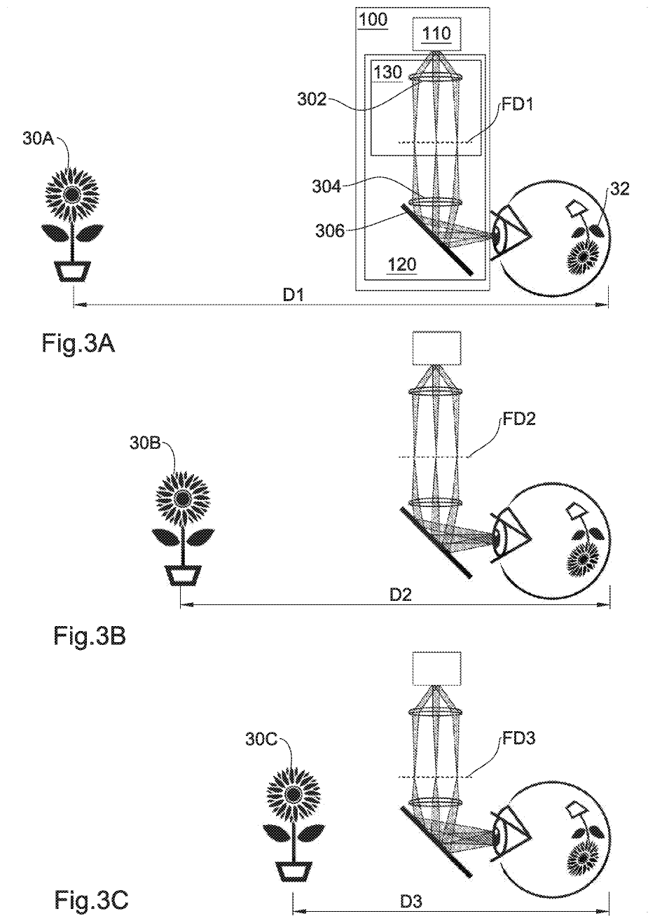

Reference is now made to FIGS. 3A-3C illustrating a non-limiting example for using the eye projection system 100 for presenting a virtual object to a user while the virtual object is in focus at different perceived distances from the user. The eye projection system 100 includes the image projection system 110, the optical assembly 120 that includes three optical elements 302, 304 and 306, and the light beam divergence assembly 130. In the described example, the light beam divergence assembly 130 is implemented by varying the effective light beam distance between the optical elements 302 and 304 which may have fixed focal lengths. It is appreciated that the light beam divergence assembly 130 can be implemented in any other configuration as explained above, or any combination of the configurations described above. By displacing the optical element 302 with respect to the optical element 304, the light beam effective distance is controllably varied. It is noted that the distance between the image projection system 110 and the optical element 302 is kept constant, e.g. by moving them together. Varying the effective distance between the optical elements 302 and 304 is illustrated by the distances FD1, FD2 and FD3 from the optical element 304. The light beam effective distance affects the divergence of the light beam(s) after passing beyond the optical element 304 towards the subject's eye. The different divergence of the light beams results in focusing of the light beam(s) at the retina of the subject's eye and producing a focused image 32 at the retina by that the subject varies the focal length of his eye by looking at different distances. Therefore, the three different displacements of the optical element 302 with respect to the optical element 304, cause the subject to perceive the virtual object 30A, 30B and 30C as being at different distances D1, D2 and D3 respectively. In other words, the objects 30A, 30B and 30C will be in focus with respect to the observing subject, only if he looks at the respective different distances D1, D2 and D3 by adjusting the focal length of his eye. If the subject maintains his focus on one of the virtual objects at one distance, the other virtual objects will then be out of focus when presented to the subject. These effects, as already has been described, are achieved by varying the divergence of the light beam(s) that produce the virtual objects on the subject's retina.

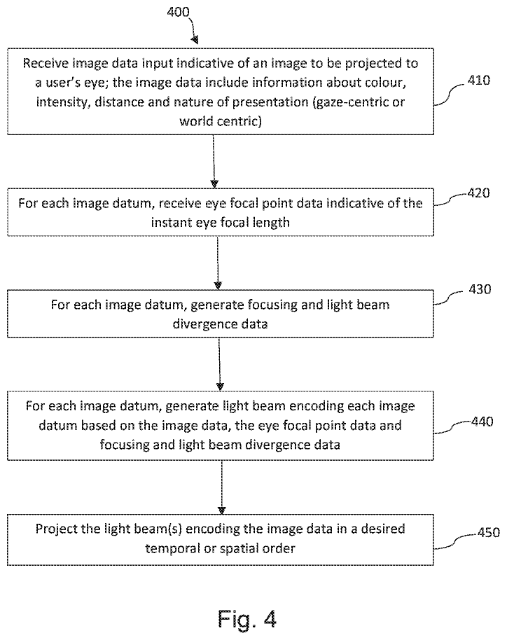

Reference is now made to FIG. 4 illustrating a method 400 for controlling focusing parameters of one or more parts of an image according to the present invention. As described above, the eye projection system includes several functions that together enable production of a convincingly realistic and convenient virtual or augmented reality experience to the user. The various components of the eye projection system are controlled by specific local controllers that communicate between each other through respective input and output utilities/interfaces, or by a central controller.

At 410, the eye projection system 100 receives via its image projection system 110, image data indicative of an image to be projected to the subject's eye EYE. For example, the image is composed of pixels (whether one-, two- or three dimensional image), and each pixel in the image is represented by an image datum. The image datum of each pixel in the image includes information such as color, intensity, distance and nature of presentation (whether it should be projected as a gaze-centric image or a world-centric image). Optionally, the user chooses whether the system should operate in gaze-centric mode or in a world-centric mode.

In the following steps, the image projection system 110 generates a series of light beams, encodes them with the corresponding image data and projects them towards the subject's eye EYE via the optical assembly 120. Accordingly, if the image is composed of Z pixels, corresponding Z encoded light beams are generated.

At 420, for each image datum, the eye projection system receives data from the eye focal point detection system 150 about the instant eye focal length.

At 430, for each image datum, the eye projection system generates data to control the light beam divergence assembly 130 in order to adjust the corresponding light beam's divergence and control its focusing on the subject's eye based on whether it represents a gaze-centric or a world-centric image.

At 440, for each image datum, the image projection system 110 generates a light beam encoding the image datum based on the image information (colour, distance, etc.), the eye focal point data and the focusing and light beam divergence data.

At 450, the eye projection system 100 projects the light beams forming the image in a desired temporal or spatial order. Typically, the image data represent a sequential order of the pixels forming the image and the image data is projected in this sequential order. However, the eye projection system can project light beams of parts of the image in an order different to the sequential order of the pixels forming the image.

1. An eye projection system, comprising:
an image projection system configured and operable for generating a light beam modulated to encode image data indicative of an image to be projected towards a subject's eye along a light beam propagation path;
an optical assembly being located in said light beam propagation path and configured and operable for directing the light beam between said image projection system and a retina of said subject's eye, said optical assembly comprising a light beam divergence assembly configured and operable for controllably varying focusing properties of said optical assembly and adjusting divergence of said light beam to thereby affect one or more focusing parameters of one or more portions of said image on the retina of the subject's eye;
an eye focal point detection system configured and operable to continuously determine a focal length of the subject's eye and generate eye focal point data to be used in controlling said light beam divergence assembly; and
at least one controller configured and operable to control said image projection system, light beam divergence assembly and eye focal point detection system.

2. The eye projection system of claim 1, wherein said light beam divergence assembly affects the one or more focusing parameters of one or more portions of the image by maintaining said one or more portions of the image in focus in every gaze distance and/or direction of the subject's eye.

3. The eye projection system of claim 1, wherein said light beam divergence assembly affects the one or more focusing parameters of one or more portions of the image by projecting said one or more portions of the image at a fixed spatial location in a field of view of said subject's eye.

4. (canceled)

5. The eye projection system of claim 41, wherein said eye focal point detection module comprises: a light source arrangement configured and operable to illuminate the subject's eye with a collimated light beam, an optical sensor distanced by a known distance from a pupil of the subject's eye and configured and operable to register reflected light beam from the subject's retina and generate reflection data, and a camera configured and operable to capture images of the subject's eye pupil and generate pupil data, thereby enabling utilizing said reflection and pupil data to determine said focal length of the subject's eye and generate said eye focal point data.

6. The eye projection system of claim 1, wherein said light beam divergence assembly comprises an optical element having a controllably variable focusing property.

7. The eye projection system of claim 1, wherein said optical assembly comprises a relay lens arrangement.

8. The eye projection system of claim 1, wherein said optical assembly comprises at least an input optical element and an output optical element, said light beam divergence assembly being configured and operable to modify a distance that the light beam passes between said input and output optical elements along said light beam propagation path.

9. The eye projection system of claim 8, wherein said light beam divergence assembly comprises an array of light beam deflectors configured and operable to direct said light beam between said input and output optical elements, at least one light beam deflector of said array is displaceable to thereby modify the distance that the light beam passes between said input and output optical elements along said light beam propagation path.

10. The eye projection system of claim 1, wherein at least part of said light beam divergence assembly is positioned before another optical element of said optical assembly along the light beam propagation path.

11. The eye projection system of claim 10, wherein said at least part of said light beam divergence assembly comprises at least two optical focusing elements displaceable with respect to each other along the light beam propagation path.

12. The eye projection system of claim 11, wherein said at least part of said light beam divergence assembly comprises an optical focusing element having a controllably variable focusing property.

13. The eye projection system of claim 12, wherein said focusing element comprises a deformable membrane being configured and operable to converge or diverge said light beam.

14. The eye projection system of claim 10, wherein said at least part of said light beam divergence assembly comprises a beam splitter, a light polarizing element, a focusing element and a light beam deflector arranged sequentially along said light beam propagation path, at least one of said focusing element and light beam deflector being displaceable with respect to the other along said light beam propagation path.

15. The eye projection system of claim 1, wherein said eye focal point detection module comprises an eye tracking assembly configured and operable to measure gaze direction of the subject's eye and generate eye positioning data, a camera configured and operable to capture size of pupil of the subject's eye and generate pupil size data, and a controller configured and operable to utilize said eye positioning data and said pupil size data and generate said focal point data.

16. A method for determining one or more focusing parameters of one or more portions of an image on a retina of a subject's eye, the method comprising:
receiving image data input indicative of an image to be projected to a user's eye; the image data comprises information about color, intensity, distance and whether the image is in-focus or out-of-focus;
receiving, for each image datum of the image data, eye focal point data indicative of instant eye focal length;
generating, for each image datum of the image data, focusing data and light beam divergence data;
generating, for each image datum of the image data, a light beam encoding each image datum based on the image data, the eye focal point data, and focusing and light beam divergence data; and
projecting the light beams encoding the image data in a desired temporal or spatial order towards the subject's eye.
